(19) United States
(12) Patent Application Publication
(10) Pub. No.: US 2010/0308203 A1
(43) Pub. Date: Dec. 9, 2010

(54) CONSTRUCTION

(75) Inventor: Andrew William Anderson Bald, Yorkshire (GB)

Correspondence Address: TREGO, HINES & LADENHEIM, PLLC, 9300 HARRIS CORNERS PARKWAY, SUITE 210, CHARLOTTE, NC, 28269-3797, US

(73) Assignee: CAIRN CROSS SOLUTIONS LIMITED, Yorkshire (GB)

(21) Appl. No.: 12/680,292

(22) PCT Filed: Sep. 26, 2008
(86) PCT No.: PCT/GB2008/050873

§ 371 Date: Mar. 26, 2010

(30) Foreign Application Priority Data
Sep. 26, 2007 (GB) 0718690.1
Jul. 4, 2008 (GB) 0812293.9

(51) Int. Cl. B28B 7/02

(52) U.S. Cl. 249/13

(57) ABSTRACT

There are provided components, assemblies and formulations for use in forming building structures and methods of construction. A moulding component (2) comprises a first portion (111) adapted to be secured to a mould and a second portion (121) linked to said first portion (111) and adapted, in use, to provide a moulding surface (22). The first portion (111) comprises a concave surface (24) and/or curved plate adapted, in use, to engage an inner surface of the mould.

### FIELD OF THE INVENTION

The invention relates to components, assemblies and formworks for use in forming building structures and methods of construction.

### BACKGROUND TO THE INVENTION

A known method of constructing building structures comprises constructing a mould or formwork to create a hollow cavity of a desired size and shape. A freely-flowing liquid form of a building material e.g. concrete is poured into the mould. Once the building material has hardened/solidified the mould is dismantled to reveal the building structure.

In some instances, it is desirable to provide such building structures with bevelled/chamfered internal and/or external edges and/or corners. This may be achieved by providing the inside of a mould with moulding components which modify the internal shape of the mould, or formwork for casting a building structure.

A number of problems exist with the above mentioned moulding components.

Firstly, wooden moulding components are often created on site for a particular mould, which is time consuming and requires the skills of an on-site joiner, particularly where the component is a corner moulding component that is constructed from the connection of two or three elongate triangular arms in a corner.

Secondly, after use, the wooden moulding components frequently end up damaged, split, or broken because they have absorbed moisture from the curing concrete and are not appropriate for re-use so are usually discarded after one, or a small number of uses. Furthermore, when a wooden moulding component is secured to a mould using a fixing means, such as a nail, protruding parts of the fixing means often create unwanted imprints on the building structure.

Plastic moulding components for bevelling/chamfering horizontal edges of building structures often comprise a triangular-shaped piece for providing a moulding surface, which is connected to a plate for securing the component to a mould. When securing the components to a mould using the plate, there is a tendency for the plate to curve at that point, which causes the moulding surface of the component to lift away from the mould to create a gap therebetween (shown in FIG. 3d). During casting of the building structure, such gaps can fill with construction material and cause an unwanted protruding lip on a chamfered edge which can be difficult and time consuming to remove.

Accordingly, the present invention aims to address at least one problem associated with the prior art whether discussed herein, or otherwise.

### SUMMARY OF THE INVENTION

According to a first aspect of the present invention there is provided a moulding component comprising a first portion adapted to be secured to a mould, a second portion linked to said first portion and adapted, in use, to provide a moulding surface and wherein said first portion comprises a concave surface and/or curved plate adapted, in use, to engage an inner surface of said mould.

Suitably, said first portion comprises a concave surface adapted, in use, to engage an inner surface of said mould.

Suitably, the moulding component comprises a chamfer edge moulding component. Suitably, the moulding component comprises a component for use in moulding a bevelled edge of a building structure. Suitably, the moulding component comprises a component for use in moulding a chamfered edge of a building structure.

Suitably, the first portion is deformable and is most suitably resiliently deformable. Suitably, the first portion is arranged to flex and is most suitably resiliently flexible. Suitably, the first portion is such that said concave surface may be deformed and/or flexed, in use, such that it lies substantially flat against an inner surface of a mould.

Suitably, the moulding component comprises a plastics material.

Suitably, the plastics material is capable of resisting the deteriorating effects of elevated temperatures up to at least 60° C. Suitably, the plastics material is capable of resisting the deteriorating effects of elevated temperatures up to 100° C.

Suitably, the plastics material is capable of resisting the deteriorating effects of reduced temperatures of 0° C. or less. Suitably, the plastics material is capable of resisting the deteriorating effects of temperatures of −25° C. or less.

Suitably, the plastics material has a tensile strength of at least 40 MPa (Mega Pascal).

Suitably, the moulding component comprises a polymer blend. Suitably, the moulding component comprises a copolymer. Suitably, the polymer blend further comprises particles distributed therein.

Suitably, the polymer blend further comprises microscopic particles. Suitably, the microscopic particles are between approximately 1 μm and 1000 μm in length. Suitably, the polymer blend further comprises submicroscopic particles. Suitably, the submicroscopic particles are less than approximately 1 μm in length. Suitably, the particles are uniformly distributed therein.

Suitably, the plastics material comprises acrylonitrile butadiene styrene (ABS).

Suitably, the plastics material comprises a polymer blend of acrylonitrile and styrene. Suitably, the moulding component comprises a styrene-acrylonitrile copolymer. Suitably, the styrene-acrylonitrile copolymer forms a matrix in which submicroscopic rubber particles are distributed. Suitably, the rubber particles are uniformly distributed in the matrix.

The plastics material may comprise polypropylene.

Suitably, the concave surface comprises an arcuate surface.

Suitably, the first portion is arranged such that in use it can deform and/or flex to allow the radius of the concave surface to be caused to increase when the first portion is secured to a mould. The depth of the concavity may thus be reduced when the component is secured to a mould. Edges of the first portion may thus be caused to press against the mould.

Suitably, the first portion is arranged such that in use it is not caused to deform and/or flex sufficiently for the concave surface to be caused to become a convex surface when the first portion is secured to a mould. Suitably, the first portion is sufficiently rigid to resist being caused to deform and/or flex to such an extent that the concave surface becomes convex. Thus, the second portion may not be caused to lift away from the mould and the formation of a gap between the mould and mould component may be minimised or prevented.

Suitably, the first portion comprises a plate. Suitably, the plate comprises all or part of said concave surface. The plate may comprise a curved plate, one side of which comprises said concave surface. Alternatively, or in addition, the plate may comprise a plate whose thickness increases towards an edge, suitably an elongate edge, such that a concave face is provided. Suitably, said plate is arranged to be secured to a mould.

Suitably, the first and second portions of the moulding component are directly connected to one another. Suitably, the first and second portions of the moulding component are integrally formed.

Suitably, the moulding component further comprises a third portion connecting the first and second portion of the moulding component. Suitably, the first and second portions of the moulding component are directly connected to one another and are also connected to one another via the third portion. Suitably, the first, second and third portion of the moulding component are integrally formed.

Suitably, the first and second portions are joined to one another by respective elongate edges. Suitably, the first and second portions are joined to form a corner. Suitably, the third and second portions are joined to one another by respective elongate edges. Suitably, the third and second portions are joined to form a corner. Suitably, an elongate edge of the third portion is joined to the first portion at a point lying between elongate edges of said first portion. Suitably, an elongate edge of the third portion is joined to a midsection of the first portion. Suitably, the third and first portions are joined to form a T-junction.

Suitably, the first, second and third portions of the moulding component each comprise walls which are joined to define a channel having a triangular cross section. Said channel may be sub-divided. Suitably, said channel is sub divided by a wall linking a mid section of the second portion to the junction of the first and third portions. Alternatively, the first, second and third portions may each comprise surfaces of a solid piece.

Suitably, the building component comprises a third portion connected to the first portion between first and second elongate edges of the first portion. Suitably, a first elongate edge of the first portion is connected to the second portion and a second elongate edge of the first portion comprises a free edge. Suitably, the part of the first portion extending between its junction with the third portion and its free edge comprises a plate.

The part of the first portion extending between its junction with the third portion and its junction with the second portion may comprise a plate which may comprise a continuation of a plate/flange which forms the part of the first portion which extends between its junction with the third portion and its free edge.

Suitably, the component comprises first, second and third portions connected to define a hollow body having a plate provided by the first portion extending therefrom.

Suitably, the component comprises a plate arranged to be secured to a mould. Suitably, the plate comprises a curved plate. Suitably, the plate comprises a curved plate having a concave surface for facing a mould. Suitably, in use, when the plate is secured to a mould the plate comprises a lesser curve. Suitably, in use the plate is substantially planar. The plate may thus lie flat against the mould in use.

Suitably, the first portion comprises a concave surface along substantially the whole of its longitudinal extent. Suitably, substantially the whole of the surface of the first component which faces a mould in use is concave.

Suitably, the first portion is arranged such that when placed on a flat surface such that first and second elongate edges of the first portion engage said surface a mid section of the surface of the first portion lies between 0.1 and 5.0 mm from said flat surface, suitably between 0.5 mm and 3.0 mm from said flat surface, for example around 2.0 mm

Suitably, the curvature of the concave surface and/or of the curved plate has a radius of approximately between 100 mm and 300 mm. More suitably, the curvature of the concave surface and/or of the curved plate has a radius of approximately between 150 mm and 250 mm. Most suitably, the curvature of the concave surface and/or of the curved plate has a radius of approximately 200 mm.

Suitably, the first portion comprises a taper which increases in thickness towards its free edge. Suitably, the first portion comprises a taper which increases in thickness towards its junction with the second portion.

Suitably, the plate of the first portion comprises a taper which increases towards its free edge. Suitably, the plate increases in thickness from a thickness at a mid section of between around 0.5 mm to 1.0 mm to a thickness at the free edge of between around 1.0 mm to 3.0 mm. The plate may for example taper from a thickness of around 0.75 mm to around 1.5 mm.

Suitably, the first portion comprises a securing means. Suitably, the first portion comprises a plate which comprises securing means.

Suitably, the securing means comprises at least one pre-formed hole, or weakness through which a fixing nail or screw can pass. Suitably, the pre-formed hole(s) is/are provided at an approximate mid-point between the free edge of the plate and its junction with the third portion.

Suitably, each pre-formed hole/weakness is provided at a point between the mid-point of the curve and the free edge of the first portion.

According to a second aspect of the present invention there is provided a moulding component comprising a first portion adapted to be secured to a mould, a second portion linked to said first portion and adapted, in use, to provide a moulding surface and wherein said component comprises biasing means for biasing an edge of the first portion towards said mould, in use.

Suitably, the biasing means is arranged to bias an edge of the first portion which is joined to an edge of the second portion towards said mould in use.

Suitably, the biasing means is arranged to bias a lowermost edge of the first portion towards said mould in use.

Suitably, the biasing means comprises a part of the first portion which is arranged to flex, suitably resiliently flex. Suitably, the biasing means comprises a part of the first portion which is arranged to deform, suitably resiliently deform.

Suitably, the biasing means comprises a sprung part of the first portion. Suitably, the sprung portion comprises a concave surface. Suitably, the sprung portion comprises a curved plate.

The moulding component may comprise any feature as described in relation to the first aspect.

According to a third aspect of the present invention there is provided a moulding assembly for use with a building structure casting mould, or formwork, or shutter, the assembly comprising at least one chamfer edge moulding component and the assembly further comprising at least one alternate moulding component.

Suitably, the moulding assembly comprises at least one chamfer edge moulding component comprising a moulding component according to the first aspect of the invention.

Suitably, the moulding assembly comprises a plurality of chamfer edge moulding components.

Suitably, the moulding assembly further comprises at least one corner moulding component.

Suitably, the corner moulding component comprises a 2 directional corner moulding comprising two arms extending from a corner in two different directions.

Suitably, the corner moulding component comprises a 3 directional corner moulding comprising three arms extending from a corner in three directions.

Suitably, the assembly comprises at least one 2 directional corner moulding and at least one 3 directional corner moulding.

Suitably, each arm of a corner moulding is arranged perpendicularly to another arm, although corner mouldings with other arrangements could be provided depending on the shape of the mould.

Suitably, each arm of a corner moulding comprises a portion adapted in use to provide a moulding surface and a portion adapted in use to engage an inner surface of said mould. Suitably, one or more arms of a corner portion are adapted to be secured to a mould.

Suitably, each corner moulding comprises at least one plate by which it can be secured to a mould. Suitably, two arms of each corner moulding comprise a plate. Suitably, said plates meet at a corner.

Suitably, the moulding assembly further comprises at least one vertical moulding component.

Suitably, the vertical moulding component comprises a portion adapted in use to provide a moulding surface and a portion adapted in use to engage an inner surface of said mould. Suitably, the vertical moulding component is adapted to be secured to a mould.

Suitably, the moulding assembly further comprises joining means for joining moulding components. Suitably, the moulding assembly comprises one or more joining members for joining moulding components to one another.

Suitably, each joining member comprises engagement means for engaging engagement means of first and second moulding components.

Suitably, each joining member comprises a first and a second engagement means for engaging respective first and second moulding components of any type described above.

Suitably therefore, each moulding component also comprises engagement means for engaging with first or second engagement means of said joining members.

Suitably, said engagement means provide an interference fit between a moulding component and a joining member.

Suitably, the engagement means of each moulding component comprises at least one cavity for receiving engagement means of a joining member. Suitably, the engagement means of the joining member comprises a projection for projecting into engagement means of a moulding component.

Suitably, each moulding component defines an enclosed channel having a triangular-shaped cross-section an open end of which provides said engagement means. Suitably, the channel of one or more of the moulding components is sub-divided into two parts to define two side-by-side cavities. Suitably therefore, the first and second engagement means of the joining members comprise pairs of projections for co-operation with said side-by-side cavities.

Suitably, each projection of the joining member comprises a tapering end portion to facilitate engagement with the cavities.

Suitably, the joining member(s) each comprise a transition face to provide a continuous moulding face between the moulding faces of two adjacent joined moulding components.

Suitably, the transition face is provided by a triangular-shaped plate member from which the first and second engagement means extend.

Suitably, the moulding assembly comprises at least one end cap to close off any cavity that is not otherwise engaged with a joining member.

Suitably, the end cap comprises a capping plate.

Suitably, the end cap comprises a means for engagement with a moulding component.

Suitably, the engagement means extends from one face of the capping plate.

Suitably, the engagement means provides an interference fit between the channel and the end cap.

Suitably, the engagement means of the end cap may comprise any feature as described in relation to the engagement means of the joining member and suitably is the same as that of the joining member.

Suitably, the moulding assembly comprises a shuttering pack.

According to a fourth aspect of the present invention there is provided a joining member for use in a moulding assembly, said joining member having any feature as described in relation to the joining member of the third aspect.

According to a fifth aspect of the present invention, there is provided an end cap for use in a moulding assembly, said end cap having any feature as described in relation to the end cap of the third aspect.

According to a sixth aspect of the present invention there is provided a corner or vertical moulding component for use in a moulding assembly, said moulding component having any feature as described in relation to a corner or vertical moulding component of the third aspect.

According to a seventh aspect of the present invention there is provided a mould formwork for casting a building structure, comprising the moulding component of the first aspect and/or the moulding component of the second aspect and/or the moulding assembly of the third aspect and/or a joining member of the fourth aspect and/or an end cap of the fifth aspect and/or a moulding component of the sixth aspect.

Suitably, the mould formwork comprises the moulding component of the first aspect and/or the moulding assembly of the third aspect secured to a mould.

Suitably, the mould formwork comprises the moulding component of the first aspect and/or the moulding assembly of the third aspect secured to a plurality of shutters or panels arranged to form a casting mould.

Suitably, the mould formwork comprises a moulding component of the first aspect.

Suitably, the mould formwork comprises a moulding assembly of the third aspect.

According to an eighth aspect of the present invention there is provided a method of forming a building structure the method comprising forming a mould formwork according to the seventh aspect and pouring a flowable building material into the mould formwork and allowing said building material to cure before removing the mould formwork from around the formed building structure.

According to a ninth aspect of the present invention there is provided a building structure manufactured with the moulding component of the first aspect and/or the moulding component of the second aspect and/or the moulding assembly of the third aspect and/or a joining member of the fourth aspect and/or an end cap of the fifth aspect and/or a moulding component of the sixth aspect and/or a mould formwork of the seventh aspect and/or the method of the eighth aspect.

According to a tenth aspect of the invention there is provided a shuttering pack of components to enable chamfer corners to be formed quickly and easily, using polypropylene mouldings.

Suitably, the shuttering pack will form horizontal chamfered internal corners by using an internal dual corner moulding.

Suitably, the shuttering pack will form horizontal external corners by using an external dual corner moulding.

Suitably, the shuttering pack will form horizontal external corners with a vertical chamfer using a tri-corner moulding.

Suitably, the shuttering pack forms a tight joint between the chamfer and a shuttering formwork by utilising a concave backing profile to minimize grout loss behind the chamfer.

Any of the features of an aspect described herein may be combined with any of the features of any other aspect except where such combinations are mutually exclusive.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 is a perspective exploded view of an assembly according to the present invention;

FIG. 2 is a perspective view of the assembly of FIG. 1;

FIG. 3a is a perspective view of a chamfer edge moulding component;

FIG. 3b is an end view of the chamfer edge moulding component of FIG. 3a;

FIG. 3c is a cross-sectional view of the chamfer edge moulding component of FIG. 3a, in use;

FIG. 3d is a cross-sectional view of a chamfer edge moulding component of the prior art, in use;

FIG. 4 is a perspective view of a joining member;

FIG. 5 is a perspective view of an end cap;

FIG. 6a is a rear perspective view of a three directional external corner moulding component;

FIG. 6b is a perspective front view of the three directional external corner moulding component of FIG. 6a;

FIG. 7 is a two directional external corner moulding component;

FIG. 8 is a perspective view of a two directional internal corner moulding component as part; and

FIG. 9 is a perspective front view of a vertical moulding component.

### DETAILED DESCRIPTION OF PREFERRED EMBODIMENTS

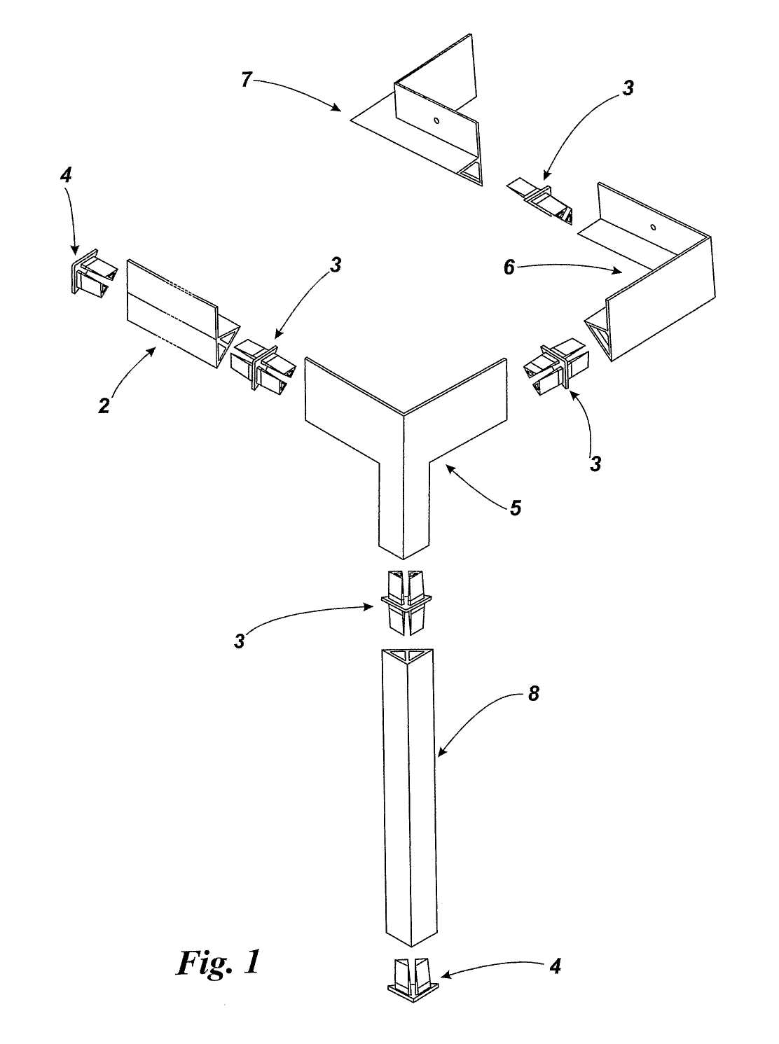

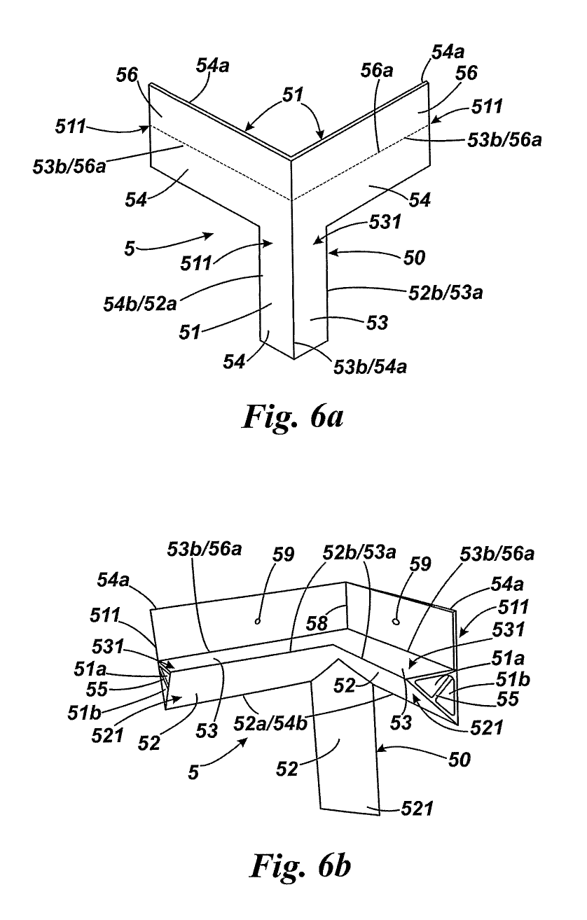

FIGS. 1 to 9 illustrate a moulding assembly and components thereof which can be used as part of a mould formwork to mould a building structure.

A mould formwork with which the assembly and components are used comprises a number of shutters or panels are fitted together to create a hollow mould (not shown) to which moulding components are secured. In use, concrete is poured into the mould and once the concrete is set the mould formwork is dismantled to reveal a concrete building structure. The moulding components are arranged in the mould to “blunt” the edges and corners of the structure formed with the mould.

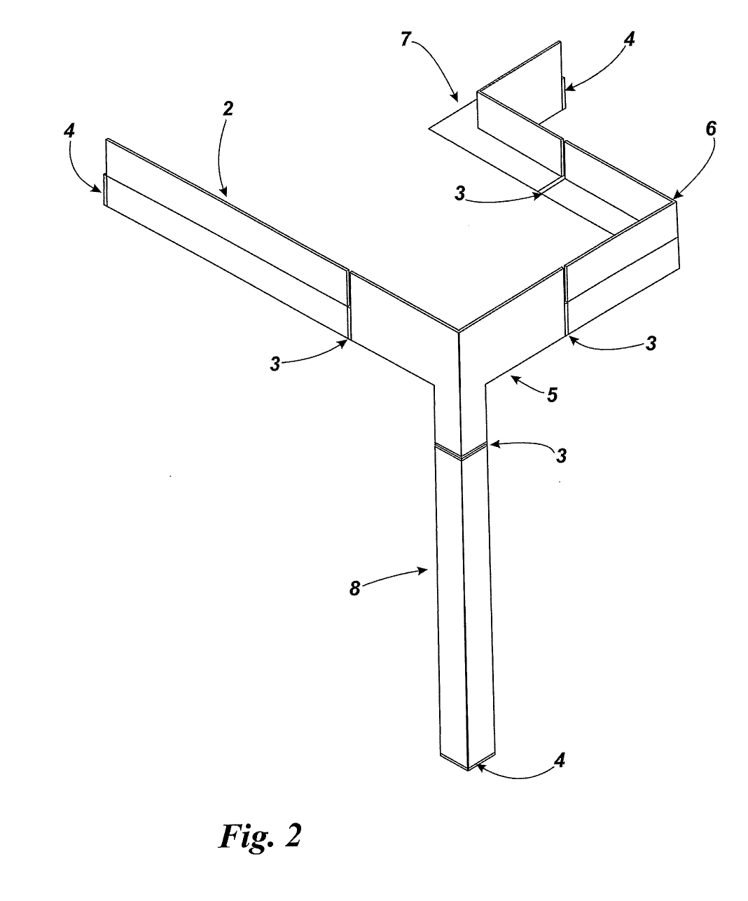

As can be seen from FIGS. 1 and 2, an assembly 1 according to the present invention comprises a plurality of components 2-8, which can be assembled and secured inside a mould in a desired configuration.

The apparatus 1 comprises a plurality of chamfer edge moulding components 2, joining members 3, end caps 4, three directional external corner moulding components 5, two directional external corner moulding components 6, two directional internal-corner moulding components 7 and vertical components 8.

As can be seen from the figures, each of the components 2, 5-8 comprises a moulded body 20, 50, 60, 70, 80. Each moulded body 20, 50, 60, 70, 80 is formed from plastics.

Each component 2, 5-8 will be described independently.

The chamfer edge moulding component 2 comprises a first portion 111 adapted to be secured to a mould, a second portion 121 linked to said first portion 111 and adapted, in use, to provide a moulding surface 22 and wherein said first portion comprises a concave surface 24 adapted, in use, to engage an inner surface of said mould.

The first portion 111 comprises a curved plate 26 providing the concave surface 24. The component 2 further comprises a third portion 131 connecting the first and second portions 111, 121 to one another. The third portion 131 has an outer surface 23. The first and second portions 111, 121 are also directly connected to one another and thus a channel having triangular cross section is defined by the portions. The third portion 131 is joined to the first portion 111 in a mid section of the first portion 111 at a junction 26a and thus a part of the first portion 111 extends beyond its junction 26a with the third portion 131 to provide a plate 26. The component 2 thus comprises first, second and third portions 111, 121, 131 connected to define a hollow body 20 having a plate 26 provided by the first portion 111 extending therefrom.

Each surface 22, 23, 24 comprises a pair of elongate edges 22a/22b, 23a/23b, 24a/24b defining a facial depth therebetween. The surface 24 provided by the first portion 111 comprises a section 24x provided on the body between edge 24b and the first portion's junction 23b/26a with the third portion and a section 24y provided by the plate 26 between free edge 24a and the first portion's junction 26a with the edge 23b of the third portion 131.

The faces 22, 23, 24 are joined along paired elongate edges 22b/23a, 24b/22a and junction 26a to form a triangle having internal angles 45°, 90° and 45° at the joins respectively.

The triangular cross-section of the body 20 is divided into two elongate triangular channels 21a, 21b, which are separated by an elongate internal reinforcing wall 25.

The plate 26 extends substantially perpendicularly to the face 23 of the third portion 131 from junction 26a. The plate 26 comprises a first surface 27 which forms a section 24y of the concave surface 24 for engaging a mould and also an opposed second surface 28.

The first surface 27 of the plate 26 gradually curves, such that the first surface 27 extends beyond the plane of the section 24x. The tangent of the curve of the first surface 27 changes from approximately 180° relative to the section 24x (approximately coplanar with section 24x) at the junction 26a, to approximately between 170° and 135° at the free edge 24a a relative to the section.

The plate 26 gradually tapers in increasing thickness from the junction 26a towards the free end 24a, the plate 26 having a thickness of approximately between 0.5 mm-2 mm at the junction 26a and the free edge 24a having a thickness of approximately between 1 mm-2 mm. The second surface 28 also curves in the same direction as the first surface 27, although the curvature is shallow relative to the curvature of the first surface 27.

In the illustrated embodiment, the plate 26 comprises pre-formed holes 29 therethrough, each hole 29 being located at an approximate midpoint between the junction 26a and the free edge 24a. Each hole 29 is capable of receiving a nail or screw fixing means.

In a different embodiment (not shown), the plate comprises areas of weakness where the plate is thinner.

It will be appreciated that in alternative embodiments the plate may comprise neither preformed holes nor areas of weakness.

The plate 26 is resiliently deflectable from the curved configuration into a configuration where the surface 24 is substantially planar, such that the surface 24 lies flat against a mould surface, in use.

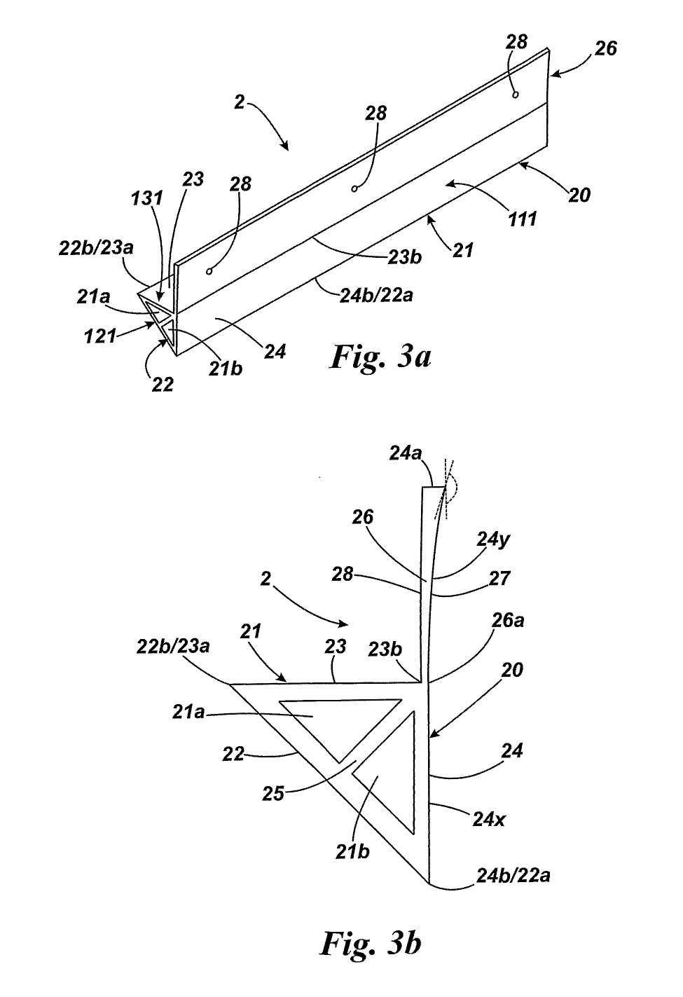

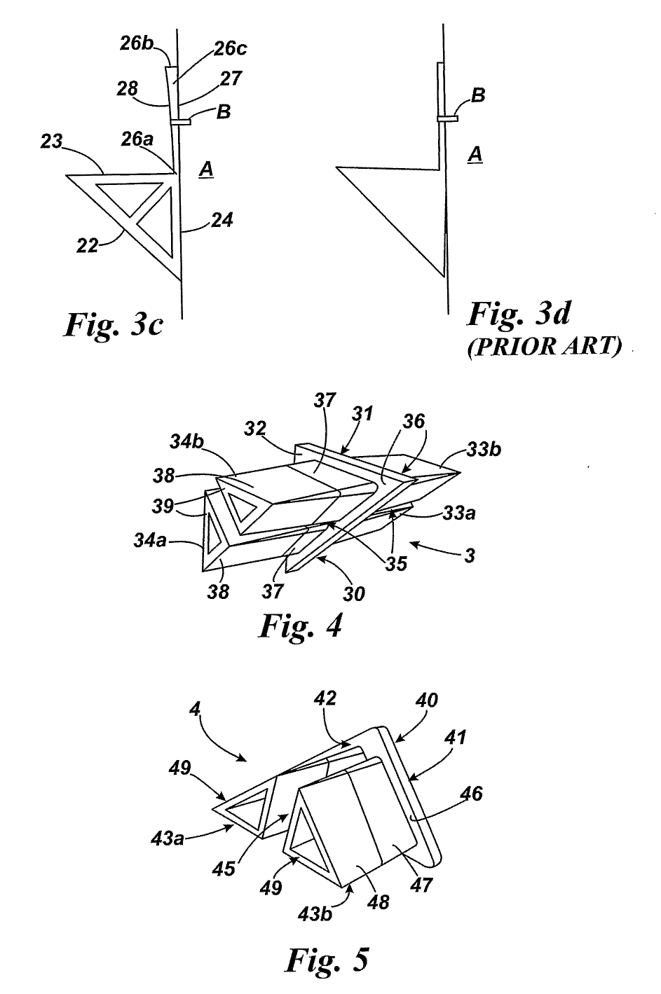

In use, the curved surface 24 is positioned against an internal face of a shutter A of a mould. Once a position is finalised, fixing means, such as a nail B is passed through the pre-formed holes 29 and tightened against the shutter A, thereby forcing the first surface 27 of the plate 26 to straighten, but without bowing convexly, thereby tending to prevent the lowermost edge 24b of the surface 24 from being caused to move away from the shutter A. Therefore, substantially full contact between the surface 24 and the shutter A can be achieved (FIG. 3c).

With this arrangement, the scenario shown in FIG. 3d for a prior art moulding component does not occur, whereby a gap between the face 24 and the shutter A is created.

The three directional external corner moulding 5 comprises the moulded body 50 having three intersecting perpendicular arms 51 of substantially hollow, right-angled triangular cross-section. Each arm 51 comprises a first portion 511 adapted, in use to provide a surface 54 to engage a mould, a second portion 521 linked to said first portion 511 and adapted, in use, to provide a moulding surface 52 and a third portion 531 connecting the first and second portions 511, 521 to one another. The third portion 531 has an outer surface 53. The first and second portions 511, 521 are also directly connected to one another and thus a channel having triangular cross section is defined by the portions 511, 521, 531.

On two of the arms 51, the third portion 531 is joined to the first portion 511 in a midsection of the first portion 511 and thus a part of the first portion 511 extends beyond its junction with the third portion 531 to provide a plate 56 on said arms. The two plates 56 of the respective arms join at a corner.

Each moulding face 52 meets in an internal right-angle to form an internal corner.

Each surface 52, 53, 54 comprises a pair of elongate edges 52a/52b, 53a/53b, 54a/54b defining a facial depth therebetween.

On two of the arms 51, the surfaces 52, 53, 54 are joined in triangular arrangement along paired elongate edges 52b/53a, 54b/52a, and junction 56a which provide internal angles 45°, 90° and 45°, respectively. On these arms 51 the plate 56 extends from junction 56a substantially perpendicularly to the surface 53 of the third portion 531.

On the third arm 51 the surfaces 52, 53, 54 are joined in triangular arrangement along paired elongate edges 52b/53a, 53b/54a, 54b/52a, which provide internal angles 45°, 90° and 45°, respectively.

The triangular cross-section of each arm 51 is divided into two elongate triangular channels 51a, 51b, which are separated by an elongate internal reinforcing wall 55.

Each plate 56 comprises pre-formed holes 59, therethrough, each hole 59 being located approximately half way between the paired edges 53b/56a and a free end 54a of the plate 56. Each hole 59 is capable of receiving a nail or screw fixing means.

In use, such a corner moulding is secured to a shutter using a nail or screw through the pre-formed holes 59 of each plate 56. The resultant chamfered internal right-angled corner of the mould can thus provide a chamfered external corner on a casted concrete building structure.

As can be seen from FIG. 7, the two directional external corner moulding 6 comprises the moulded body 60 having two intersecting perpendicular arms 61 of substantially hollow, right-angled triangular cross-section. Each arm comprises a first portion 611 adapted, in use, to provide a surface 64 for engaging a mould, a second portion 621 linked to said first portion 611 and adapted, in use, to provide a moulding surface 62 and a third portion 631 connecting the first and second portions 611, 621 to one another. The third portion 631 has an outer surface 63. The first and second portions 611, 621 are also directly connected to one another and thus a channel having triangular cross section is defined by the portions 611, 621, 631.

The third portion 631 is joined to the first portion 611 in a midsection of the first portion 611 and thus a part of the first portion 611 extends beyond its junction with the third portion 631 to provide a plate 66. The two plates 66 of the respective arms join at a corner.

Each moulding face 62 meets in an internal right-angle to form an internal corner.

Each surface 62, 63, 64 comprises a pair of elongate edges 62a/62b, 63a/63b, 64a/64b defining a facial depth therebetween. The surfaces 62, 63, 64 are joined in triangular arrangement along paired elongate edges 62b/63a, 64b/62a, and edge 63b with junction 66a which provide internal angles 45°, 90° and 45°, respectively.

The triangular cross-section of each arm 61 is divided into two elongate triangular channels 61a, 61b, which are separated by an elongate internal reinforcing wall 65.

The plates 66 on each arm 61 extend substantially perpendicularly to the surface 63 of the third portion 631 from junction 66a.

In the illustrated embodiment, each plate 66 comprises at least one pre-formed hole 69, therethrough, each hole 69 being located approximately half way between the paired edges 63b/66a and a free end 64a of the plate 66. Each hole 69 is capable of receiving a nail or screw fixing means.

In a different embodiment (not shown), the plate comprises areas of weakness where the plate is thinner.

It will be appreciated that the plate may comprise neither preformed holes nor areas of weakness.

In a further embodiment (not illustrated), the arm 61 which is without a plate 66 and which is arranged to be the vertical arm in use, is provided with depressions (not shown) in the moulding surface to facilitate driving of a fixing means through the arm and into the mould surface.

In use, such a corner moulding is secured to a shutter using a nail or screw through the pre-formed hole(s) 69 of each plate 66. The resultant chamfered internal right-angled corner of the mould, provides a chamfered external corner on a casted concrete building structure.

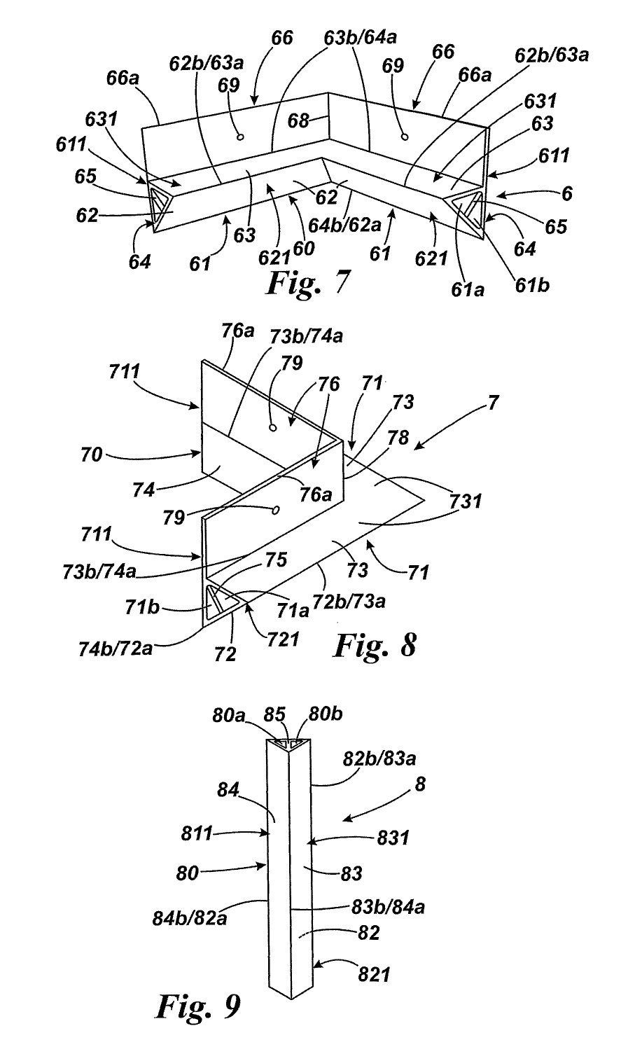

As shown in FIG. 8, the two directional internal corner moulding 7 comprises the moulded body 70 having two intersecting perpendicular arms 71 of substantially hollow, right-angled triangular cross-section. Each arm comprises a first portion 711 adapted, in use, to provide a surface 74 to be secured to a mould, a second portion 721 linked to said first portion 711 and adapted, in use, to provide a moulding surface 72 and a third portion 731 connecting the first and second portions 711, 721 to one another. The third portion 731 has an outer surface 73. The first and second portions 711, 721 are also directly connected to one another and thus a channel having triangular cross section is defined by the portions 711, 721, 731.

The third portion 731 is joined to the first portion 711 in a midsection of the first portion 711 and thus a part of the first portion 711 extends beyond its junction with the third portion 731 to provide a plate 76. The two plates 76 of the respective arms join at a corner.

The arms 71 thus comprise first 711, second 721 and third 731 portions connected to define three directional hollow body 70, the arms 71 providing plates 76 provided by first portions 711 of the arms 71 extending therefrom.

Each moulding surface 72 is co-planar with a moulding surface 72 of an adjacent arm 71. Each moulding face 72 meets in an internal right-angle to form an internal corner.

Each surface 72, 73, 74 comprises a pair of elongate edges 72a/72b, 73a/73b, 74a/74b defining a facial depth therebetween. The surfaces 72, 73, 74 are joined in triangular arrangement along paired elongate edges 72b/73a, 74b/72a, and edge 73b with junction 76a which provide internal angles 45°, 90° and 45°, respectively.

The triangular cross-section of each arm 71 is divided into two elongate triangular channels 71a, 71b, which are separated by an elongate internal reinforcing wall 75.

The elongate plates 76 extend substantially perpendicularly to the respective surface 73 of the third portion 731 from junction 76a.

In the illustrated embodiment, each plate 76 comprises pre-formed holes 79, therethrough, each hole 79 being located approximately half way between the paired edges 73b/76a and a free end 74a of the plate 76. Each hole 79 is capable of receiving a nail or screw fixing means.

In a different embodiment (not shown), the plate comprises areas of weakness where the plate is thinner.

It will be appreciated that in alternative embodiments the plate may comprise neither preformed holes nor areas of weakness.

In use, such a corner moulding is secured to a shutter using a nail or screw through the pre-formed holes 79 of each plate 76. The resultant chamfered internal right-angled corner of the mould may thus provide a chamfered internal corner on a casted concrete building structure.

The vertical component 8 comprises an elongate moulded body 80 of substantially hollow, right-angled triangular cross-section.

The body 80 comprises a first portion 811 adapted, in use, to provide a first surface 84 for engaging a mould, a second portion 821 linked to said first portion 811 and adapted, in use, to provide a moulding surface 82 and a third portion 831 connecting the first and second portions 811, 821 to one another, to provide a second surface 83 to be secured to a mould. The first and second portions 811, 821 are also directly connected to one another and thus a channel having triangular cross section is defined by the portions 811, 821, 831.

Each surface 82, 83, 84 comprises a pair of elongate edges 82a/82b, 83a/83b, 84a/84b defining a facial depth therebetween. The surfaces 82, 83, 84 are joined in triangular arrangement along paired elongate edges 82b/83a, 83b/84a, 84b/82a, which provide internal angles 45°, 90° and 45°, respectively.

The triangular cross-section of each arm 80 is divided into two elongate triangular channels 80a, 80b, which are separated by an elongate internal reinforcing wall 85.

In use, such a corner moulding is secured to a shutter using one of more nails or screws through the moulding face 82. The resultant chamfered internal vertical edge of the mould, provides a chamfered internal corner on a casted concrete building structure.

Each of the arms 21,51,56,71,80 of each of the components 2, 5-8 of the illustrated embodiment comprises the same triangular cross-sectional shape and size.

The components 2, 5-8 are conveniently assembled using joining members 3 and free ends are capped using end caps 4, thereby preventing concrete from getting into the hollow arms of each of the components 2, 5-8.

Referring to FIG. 4, a joining member 3 comprises a flat triangular-shaped plate 30 having planar faces 31, 32, the plate 30 being substantially the same shape and size as the triangular cross-section of each of the components 21, 51, 61, 71, 80.

Pairs of triangular protrusions 33a, 33b, 34a, 34b extend from each side of the plate 30. Each protrusion 33a, 33b, 34a, 34b is adapted to co-operate with a channel 21a/b, 51a/b, 61a/b, 71a/b, 80a/b on each of the components 21, 51, 61, 71, 80 and is shaped accordingly. The protrusions 33a, 33b, 34a, 34b comprise a retaining portion 37 adjacent to the plate 30, which is sized for an interference fit with a channel 21a/b, 51a/b, 61a/b, 71a/b, 80a/b. The protrusions 33a, 33b, 34a, 34b further comprise a guiding portion 38, through which the triangular cross-section of each protrusion decreases in size through tapering walls, towards a free end 39 of each protrusion 33a, 33b, 34a, 34b.

Each pair of protrusions 33a/33b, 34a/34b, comprises a gap therebetween to accommodate the internal reinforcing walls 25, 55, 65, 75, 85 of each component 21, 51, 61, 71, 80.

Furthermore, a peripheral ledge 36 is provided around each pair of protrusions 33a/33b, 34a/34b.

In use, the joining member 3 provides a universal double-sided plug member, which engages with the channels 21a/b, 51a/b, 61a/b, 71a/b, 80a/b of each of the components 21, 51, 61, 71, 80 to provide an interference fit via the retaining portion 37 of each protrusion. The peripheral ledges 36 of the plate member 30 abut an end of a component 21, 51, 61, 71, 80 so that the edges of the plate member 30 are flush with the respective faces 22/23/24, 52/53/54-82/83/84 of the respective component 21, 51, 61, 71, 80. The plate member 30 can thus provide a transitional moulding face or strip between moulding faces of adjacently joined moulding components.

Referring to FIG. 5, the end cap 4 comprises a flat triangular-shaped plate 40 having planar faces 41, 42, the plate 40 being substantially the same shape and size as the triangular cross-section of each of the components 21, 51, 61, 71, 80. A pair of triangular protrusions 43a, 43b, extends from one face 42 of the plate 40. Each protrusion 43a,43b, corresponds to a channel 21a/b, 51a/b, 61a/b, 71a/b, 80a/b on each of the components 21, 51, 61, 71, 80 and is shaped accordingly. The protrusions 43a, 43b comprise a retaining portion 47 adjacent to the plate 40, which is sized for an interference fit with a channel 21a/b, 51a/b, 61a/b, 71a/b, 80a/b. The protrusions 43a, 43b further comprise a guiding portion 48, through which the triangular cross-section of each protrusion decreases in size through tapering walls, towards a free end 49 of each protrusion 43a, 43b.

A gap 45 is provided between the pair of protrusions 43a/43b, to accommodate the internal reinforcing walls 25, 55, 65, 75, 85 of each component 21, 51, 61, 71, 80, in use. Therefore, protrusion 43a, corresponds to the channels 21a, 51a, 61a, 71a, 80a, whereas protrusion 43b, corresponds to the channels 21b, 51b, 61b, 71b, 80b. Furthermore, a peripheral ledge 46 is provided around the pair of protrusions 43a/43b.

In use, the end cap 4 provides a universal single-sided plug member, which engages with the channels 21a/b, 51a/b, 61a/b, 71a/b, 80a/b of each of the components 21, 51, 61, 71, 80 to provide an interference fit via the retaining portion 37 of each protrusion. The peripheral ledges 46 of the plate member 40 abut an end of a component 21, 51, 61, 71, 80 so that the edges of the plate member 40 are flush with the respective faces 22/23/24, 52/53/54-82/83/84 of the respective component 21, 51, 61, 71, 80.

The components of the apparatus of the preferred embodiment are provided as an assembly/kit, with a plurality of each of the components 2-8 being provided, so that the assembly components can be joined to fit various moulds sizes and shapes.

Each moulded body 20-80 of each component 2-8 comprises acrylonitrile butadiene styrene (ABS), which comprises a two phase continuous copolymer matrix (styrene-acrylonitrile), in which submicroscopic (less than 1 μm in length) rubber particles are uniformly distributed. ABS is a rigid, hard, heat resistant material with a tensile strength of approximately 40-50 MPa, a notched impact strength of approximately 10-20 Kj/m² and an ability to be resistant to temperatures of approximately 80-90° C. However, it will be appreciated that other material with similar properties could be used.

It will be appreciated that preferred embodiments of the present invention may provide a number of advantages to the construction industry.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment. The invention extends to any novel one, or any novel combination, of the features disclosed in this specification (including any accompanying claims, abstract and drawings), or to any novel one, or any novel combination, of the steps of any method or process so disclosed.

1. A moulding component comprising a first portion adapted to be secured to a mould, a second portion linked to said first portion and adapted, in use, to provide a moulding surface and wherein said first portion comprises a concave surface and/or curved plate adapted, in use, to engage an inner surface of said mould.

2. A moulding component according to claim 1, wherein the moulding component comprises a chamfer edge moulding component.

3. A moulding component according to claim 1, wherein the first portion is such that said concave surface may be deformed and/or flexed, in use, such that it lies substantially flat against an inner surface of a mould.

4. A moulding component according to claim 1, wherein the concave surface comprises an arcuate surface.

5. A moulding component according to claim 1, wherein the first portion comprises a plate.

6. A moulding component according to claim 1 wherein the first portion comprises a plate and wherein the plate comprises all or part of said concave surface.

7. A moulding component according to claim 1 wherein the first portion comprises a plate whose thickness increases towards an elongate edge, such that a concave face is provided.

8. (canceled)

9. A moulding component according to claim 1, wherein the moulding component further comprises a third portion connecting the first and second portion of the moulding component and wherein an elongate edge of the third portion is joined to the first portion at a point lying between elongate edges of said first portion at a midsection of the first portion.

10. (canceled)

11. A moulding component according to claim 1 wherein the moulding component further comprises a third portion connecting the first and second portion of the moulding component and wherein an elongate edge of the third portion is joined to the first portion at a point lying between elongate edges of said first portion at a midsection of the first portion and wherein one first elongate edge of the first portion is connected to the second portion and a second elongate edge of the first portion comprises a free edge.

12. (canceled)

13. (canceled)

14. A moulding component according to claim 1, wherein the curvature of the concave surface and/or of the curved plate has a radius of approximately between 100 mm and 300 mm.

15. A moulding component comprising a first portion adapted to be secured to a mould, a second portion linked to said first portion and adapted, in use, to provide a moulding surface and wherein said component comprises biasing means for biasing an edge of the first portion towards said mould, in use.

16. A moulding component according to claim 1, wherein the biasing means is arranged to bias a lowermost edge of the first portion towards said mould in use.

17. A moulding component according to claim 16, wherein the biasing means comprises a sprung part of the first portion.

18. (canceled)

19. A moulding assembly for use with a building structure casting mould, or formwork, or shutter, the assembly comprising at least one chamfer edge moulding component and the assembly further comprising at least one alternate moulding component.

20. A moulding assembly for use with a building structure casting mould, or formwork, or shutter, the assembly comprising at least one chamfer edge moulding component and the assembly further comprising at least one alternate moulding component, wherein the chamfer edge moulding component comprises a moulding component according to claim 1 and wherein the assembly further comprises at least one corner moulding component and/or at least one two-directional corner moulding and at least one three-directional corner moulding and/or at least one vertical moulding component and/or one or more joining members for joining moulding components to one another.

21-27. (canceled)

28. A joining member for use in a moulding assembly wherein the joining member comprises engagement means for engaging engagement means of first and second moulding components.

29. (canceled)

30. (canceled)

31. A mould formwork for casting a building structure, comprising the moulding component according to claim 1.

32. A method of forming a building structure the method comprising forming a mould formwork for casting a building structure, said framework comprising the moulding component according to claim 1, and pouring a flowable building material into the mould formwork and allowing said building material to cure before removing the mould formwork from around the formed building structure.

33. A building structure manufactured with the moulding component according to claim 1.

34. A shuttering pack of components to enable chamfer corners to be formed quickly and easily, using polypropylene mouldings.
